(19) United States
(12) Patent Application Publication
(10) Pub. No.: US 2025/0144488 A1
(43) Pub. Date: May 8, 2025

(54) GOLF ARTICLE CLEANER

(71) Applicant: N-RIT CO., LTD., Paju-si Gyeonggi-do (KR)

(72) Inventor: Dae Up SOHN, Paju-si Gyeonggi-do (KR)

(21) Appl. No.: 18/833,884

(22) PCT Filed: Jan. 16, 2023
(86) PCT No.: PCT/KR2023/000720

§ 371 Date: Jul. 27, 2024

(30) Foreign Application Priority Data
Jan. 27, 2022 (KR) 10-2022-0012560

(51) Int. Cl. A63B 57/60; A63B 47/04; A63B 57/20; B08B 1/14

(52) U.S. Cl. CPC A63B 57/60; B08B 1/143; A63B 47/04; A63B 57/203; A63B 57/207; A63B 2209/08

(57) ABSTRACT

The present invention relates to a golf article cleaner which can conveniently and cleanly wash a golf article during a golf game process and which is easy to store and thus can prevent the spread of contamination after washing the golf article. The golf article cleaner includes an inner surface portion that functions as an inner shell and washes the golf article, and an outer surface portion that functions as an outer shell and is sewn around the inner surface portion, wherein the inner surface portion is composed of a first inner surface part and a second inner surface part, which are separate in an overlapping state, the second inner surface part being provided to be continuous from the first inner surface part, and, in order to enlarge a washing area, the upper portion of the first inner surface part and the upper portion of the second inner surface part are configured to be detachably deployed, so that foreign substances attached to the surface and grooves of the golf article can be easily washed.

### TECHNICAL FIELD

The present invention relates to a golf article cleaner, and more particularly, to a golf article cleaner capable of conveniently and cleanly cleaning a golf ball, a golf club head, or the like (hereinafter, referred to as a “golf article”) using an expanded cleaning area during the course of a golf game and capable of preventing the spread of contamination after the golf article is cleaned because the cleaner is easily stored.

### BACKGROUND ART

In general, a task of cleanly cleaning golf club heads or golf balls during a golf game is generally a method of removing mud or grass attached to golf articles using a cloth such as a towel or a general brush.

Such a towel or brush is mainly carried and used by a caddy, but when there is no caddy, a player plays the game after cleaning the golf articles using a towel, a brush, or a similar item or roughly removing grass attached to a club head or dimples of a golf ball using his or her hands without cleaning the golf articles using the towel, the brushes, or the similar item during the game.

That is, grooves of the club head are provided to temporarily hold the golf ball during a high-speed swing to cause backspin that causes the golf ball to rise and fly higher. 350 to 400 dimples per one golf ball are provided to reduce air resistance and increase a flying distance. After the golf ball is hit, mud or grass is stuck to the grooves of the club head or the dimples of the golf ball and is not easily separated therefrom. When the golf ball is hit without cleaning these foreign substances, the foreign substances between the ball and the club head may seriously adversely affect the flying distance and direction of the golf ball. Thus, the hitting should be performed after the club head and the golf ball are cleaned by removing the foreign substances.

A towel illustrated in FIGS. 1 and 2 is commercially available as a towel for cleaning a golf ball or the like. FIG. 1 is a view illustrating an example of a golf ball cleaner according to the related art, and FIG. 2 is a view illustrating another example of the golf ball cleaner according to the related art.

A golf ball cleaner 10 in a folded state illustrated in (a) of FIG. 1 has a structure in which an inner surface portion 13 is provided as a general towel, the entire upper portion of an outer surface portion 11 is sewn along a sewing line 12 and is provided in a pocket shape, an eyelet 20 is attached to an edge, and a reel wire 30 is coupled to the eyelet 20 through a connection ring 31. As illustrated in (b) of FIG. 1, the cleaner 10 may have an open edge of a side surface and clean a golf ball 50 inserted into the inner surface portion 13, but since the inner surface portion 13 has a general towel structure, only a surface portion of the golf ball 50 is cleaned, and only some dimples 51 formed as a plurality of grooves are cleaned.

Further, the foldable tower cleaner 10 illustrated in FIG. 2 has a structure in which the outer surface portion 11 is waterproof and the inner surface portion 13 is made of microfiber and which is used while coupled to a golf back through a reel wire 30 or worn on a waist of a user or a back pocket. However, there are inconveniences in that pants of the user were contaminated after the golf article was cleaned or an operation such as the golf swing was encumbered.

Examples of this technology are disclosed in Patent Documents 1 to 3.

For example, Patent Document 1 (Korean Patent Publication No. 2019-0130231, published on Nov. 22, 2019) discloses a golf article cleaner which includes a pocket-shaped pouch body having at least one open side and a connection member formed at one end of the pouch body and removes foreign substances attached to the golf article using the inside of the pouch body and in which the pouch body is provided with an inner pouch portion provided in in the form of a towel or cloth to easily remove foreign substances attached to the golf article and an outer surface portion having a waterproofing function.

Further, Patent Document 2 (Korean Patent Publication No. 10-1332246, registered on Nov. 18, 2013) discloses a sports ball cleaner which includes a cleaning member including a first inner skin and a second inner skin and a waterproofing member including an outer skin surrounding the first inner skin and the second inner skin and in which the first inner skin is alternately woven with microfibers and warps and is woven such that the microfibers protrude further than the warps, the second inner skin is alternately woven with microfibers and warps and is woven such that the warps protrude further than the microfibers, and a depth of a cleaning member in the pouch shape is 1.5 to 1.7 times a diameter of the sports ball.

Meanwhile, Patent Document 3 (Korean Patent Publication No. 10-0881888, registered on Jan. 29, 2009) discloses a portable golf cleaner which includes a cloth and a moisture supply unit formed in the cloth and in which a towel is installed on a front surface or a rear surface of the cloth, a golf tee insertion portion is formed in the towel, the cloth is made of microfibers, a rear surface of the microfiber cloth is coated with silicone, and the moisture supply unit includes a moisture absorber and a support cloth that surrounds and supports the moisture absorber.

### DISCLOSURE

### Technical Problem

In a technology disclosed in Patent Document 1 as described above, as illustrated in FIG. 1, a structure in which a pouch body is formed in a quadrangular shape like a folded handkerchief and formed in a pocket shape with two open sides is provided. Thus, a golf ball may be cleaned, but a golf club head, particularly, a driver club head, may not be cleaned. Further, while the golf ball is cleaned, a user may clean the golf ball only with one hand, and thus the cleaning is not evenly performed.

Further, Patent Document 2 is a structure in which a depth of a cleaning member is 1.5 times to 1.7 times a diameter of a sports ball in the pouch shape. Only the golf ball may be cleaned, but grooves of the driver club head may not be cleaned as in Patent Document 1.

Meanwhile, Patent Document 3 discloses a technology of cleaning a golf article using moisture supplied from a moisture supply unit, and such a portable golf cleaner may be applied to a golf bag, but is difficult for a user to wear directly.

Further, in the cleaner according to the related art as illustrated in FIG. 1, an interior thereof is open through an edge of a side surface, and thus golf articles having various sizes cannot be cleaned.

The present invention is made to solve the problems described above, and the present invention is directed to providing a golf article cleaner of which a cleaning area is expanded to easily clean golf articles having various sizes.

The present invention is also directed to providing a golf article cleaner that is portable and enables a user to cleanly remove foreign substances such as grass or mud attached to a golf article with both hands during a game.

The present invention is also directed to providing a golf article cleaner that is waterproof-treated and may be portable in a pouch of the user without being affected by moisture.

The present invention is also directed to providing a golf article cleaner capable of preventing a golf article from being lost during use on a golf course or the like.

The present invention is also directed to providing a golf article cleaner capable of easily accommodating a golf article used on a golf course or the like.

The present invention is also directed to providing a golf article cleaner capable of reducing manufacturing costs for cleaning a golf article and improving cleaning efficiency.

### Technical Solution

To achieve the above purposes, a golf article cleaner according to the present invention is for cleaning various golf articles and includes an inner surface portion functioning as an inner skin and configured to clean the golf article, and an outer surface portion functioning as an outer skin and sewn around the inner surface portion, wherein the inner surface portion includes a first inner surface portion and a second inner surface portion continuing from the first inner surface portion, which are divided in a stacked state, and an upper portion of the first inner surface portion and an upper portion of the second inner surface portion are detachably deployed to expand a cleaning area.

Further, in the golf article cleaner according to the present invention, the first inner surface portion and the second inner surface portion may be provided with a first cleaning member and a second cleaning member provided with the first cleaning member in series, respectively, and the first cleaning member and the second cleaning member may have different structures.

Further, in the golf article cleaner according to the present invention, the first cleaning member may be made of a terry fabric to clean foreign substances attached to a surface of the golf article, and the second cleaning member may be made of a loop-shaped weave to clean foreign substances attached to the surface and grooves of the golf article.

Further, in the golf article cleaner according to the present invention, the golf article cleaner may further include a magnet member provided to expand the cleaning area, wherein the magnet member may include a first magnet member provided at the upper portion of the first inner surface portion and a second magnet member provided at the upper portion of the second inner surface portion, and the first inner surface portion and the second inner surface portion may be maintained in a stacked state due to an attractive force between the first magnet member and the second magnet member.

Further, in the golf article cleaner according to the present invention, each of the first magnet member and the second magnet member may be arranged to be spaced a certain distance from a side surface of the outer surface portion.

Further, in the golf article cleaner according to the present invention, the upper portion of the first inner surface portion and the upper portion of the second inner surface portion part may be sewn to be spaced a certain distance from a side surface of the outer surface portion.

Further, in the golf article cleaner according to the present invention, the first cleaning member and the second cleaning member may be provided symmetrically to each other in a front-rear direction and a vertical direction.

Further, in the golf article cleaner according to the present invention, the outer surface portion may be made of a waterproof material or a waterproof-treated material.

Further, in the golf article cleaner according to the present invention, an eyelet passing through the outer surface portion, the first inner surface portion, and the second inner surface portion may be provided at a stacked portion of the upper portion of the first inner surface portion and the upper portion of the second inner surface portion, and a connection ring may be coupled to the eyelet, and a reel wire may be connected to the connection ring.

Further, in the golf article cleaner according to the present invention, an eyelet may be provided at each of the upper portion of the first inner surface portion and the upper portion of the second inner surface portion, and a connection ring may be coupled to the eyelet, and a reel wire may be connected to the connection ring.

Further, in the golf article cleaner according to the present invention, a ring member may be provided at an upper portion of the outer surface portion, and a connection ring may be coupled to the ring member, and a reel wire may be connected to the connection ring.

Further, in the golf article cleaner according to the present invention, an insertion portion into which the golf article is inserted may be provided on the outer surface portion.

Further, in the golf article cleaner according to the present invention, a ring-shaped advertisement display member may be provided on the outer surface portion, and the golf article may be inserted into the advertisement display member.

Further, in the golf article cleaner according to the present invention, the golf article made of a metal material may be attached to the magnet member.

### Advantageous Effects

As described above, according to a golf article cleaner according to the present invention, a first cleaning member and a second cleaning member are provided in different structures, and thus foreign substances attached to surfaces and grooves of a golf article can be easily cleaned.

Further, a golf article cleaner according to the present invention can be used after an inner surface portion is deployed to expand a cleaning area, and thus golf articles having various sizes can be cleaned.

Further, a golf article cleaner according to the present invention can clean a golf article using both hands of a user, and thus the golf article can be cleanly cleaned.

Further, according to the golf article cleaner according to the present invention, a golf article such as a golf tee and a ball marker can be easily accommodated in the cleaner, and thus convenience of use can be achieved.

Further, according to the golf article cleaner according to the present invention, a first cleaning member and a second cleaning member can be provided to be woven at once using the same fabric, and thus manufacturing costs for cleaning a golf article can be reduced, and cleaning efficiency can be improved.

### DESCRIPTION OF DRAWINGS

FIG. 1 is a view illustrating an example of a golf ball cleaner according to the related art.

FIG. 2 is a view illustrating another example of a golf ball cleaner according to the related art.

FIG. 3 is a view illustrating a golf article cleaner according to a first embodiment of the present invention.

FIG. 4 is a view illustrating an upper portion of an inner surface portion in the golf article cleaner illustrated in FIG. 3 in an open state.

FIG. 5 is a view illustrating a deployed state of the golf article cleaner illustrated in FIG. 3.

FIG. 6 is an enlarged picture of a cleaning member illustrated in FIG. 5.

FIG. 7 is a view illustrating a modified example of the golf article cleaner according to the first embodiment of the present invention.

FIG. 8 is a view for describing a state of cleaning a golf ball using the golf article cleaner according to the first embodiment and the modified example of the present invention.

FIG. 9 is a view for describing a state of a golf club head being cleaned using the golf article cleaner according to the first embodiment of the present invention.

FIGS. 10 to 12 are views for describing a mounting state of the golf article cleaner according to the present invention.

FIG. 13 is a view illustrating a golf article cleaner according to a second embodiment of the present invention.

FIG. 14 is a view illustrating a golf article cleaner according to a third embodiment of the present invention.

FIG. 15 is a view illustrating a deployed state of the golf article cleaner illustrated in FIG. 14.

FIGS. 16 to 19 are views of a fourth embodiment to which the golf article cleaner illustrated in FIG. 3 is applied.

### MODES OF THE INVENTION

The above and other purposes and new features of the present invention will become more apparent from the description of the present specification and the accompanying drawings.

Among terms used herein, terms such as “include,” “comprise,” and “have” are intended to indicate that an element may be inherent unless specifically stated otherwise, and therefore, these terms may be interpreted as further including other components rather than excluding other elements. Further, terms such as first and second are used merely to distinguish a first component from a second component, and these terms do not limit the nature, the order, or the sequence of the corresponding components.

The term “member” used herein may refer to a basic structural part, and “golf article” may refer to an article necessary for hitting a golf ball and may include the golf ball, a golf club, a golf bag, a head cover, a golf tee, a ball marker, and the like.

Further, terms “microfiber” used herein means fabric made of a thread having a thickness of 1 denier or less and having excellent moisture absorption and washing ability, “Terry” is a ring-like fluff of the fabric, “Terry cloth” is a towel fabric that has a pile-like structure made by stretching threads from a surface of the fabric, and a “loop-shaped weave” means a weave obtained while maintaining a loop shape without cutting on the surface of the fabric in order for strong cleaning.

Meanwhile, the term “upper portion” used herein means, for example, a part in which an eyelet or a ring member is provided for a user to wear in a quadrangular cleaner, the term “lower portion” means a lower portion provided to correspond to the above-described upper portion, and the term “side surface” means a portion provided between the upper portion and the lower portion described above.

Hereinafter, embodiments according to the present invention will be described.

### FIRST EMBODIMENT

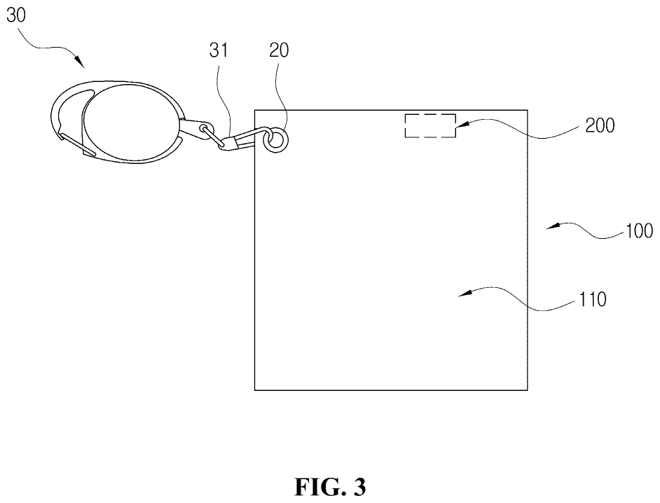

A first embodiment according to the present invention will be described with reference to FIGS. 3 to 5.

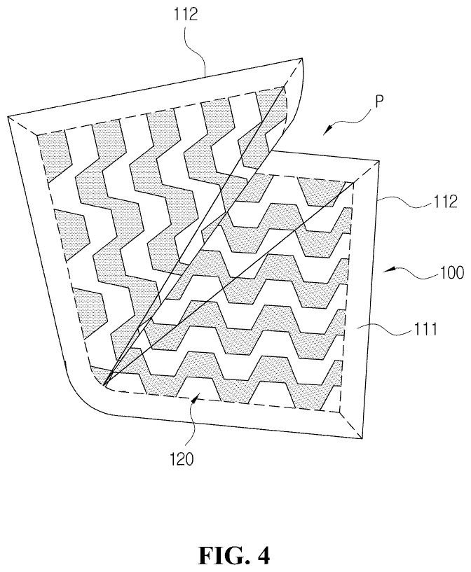

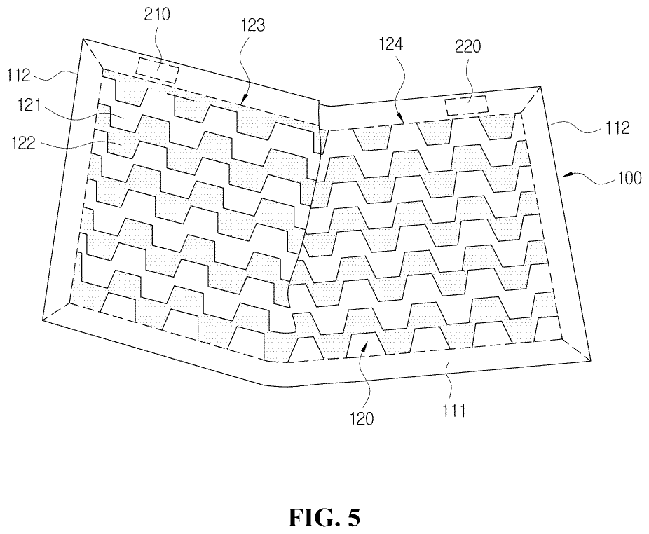

FIG. 3 is a view illustrating a golf article cleaner according to a first embodiment of the present invention, FIG. 4 is a view illustrating an upper portion of an inner surface portion in the golf article cleaner illustrated in FIG. 3 in an open state, and FIG. 5 is a view illustrating a deployed state of the golf article cleaner illustrated in FIG. 3.

As illustrated in FIGS. 3 and 4, the golf article cleaner according to the present invention is a golf article cleaner 100 that may clean various golf articles in a roughly quadrangular folded state and may be unfolded to expand a cleaning area and which includes an outer surface portion 110 that is provided to clean a golf ball, a golf club, or the like, is made of a fiber, and functions as an outer skin and an inner surface portion 120 functioning as an inner skin for cleaning the golf article. Further, as illustrated in FIG. 3, the golf article cleaner 100 according to the present invention may include a magnet member 200 embedded in an upper portion of the outer surface portion 110 to expand the cleaning area of the cleaner. Meanwhile, the golf article cleaner 100 illustrated in FIG. 3 has a quadrangular folded structure, but the present invention is not limited thereto, and the golf article cleaner 100 in a folded structure may be provided in a polygonal shape such as a triangular shape or a pentagonal shape or provided in a circular shape or an elliptic shape.

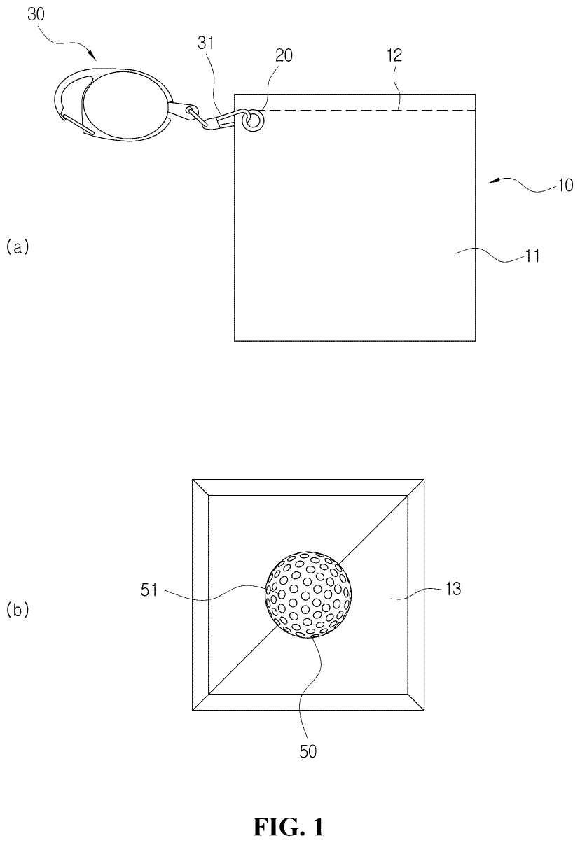

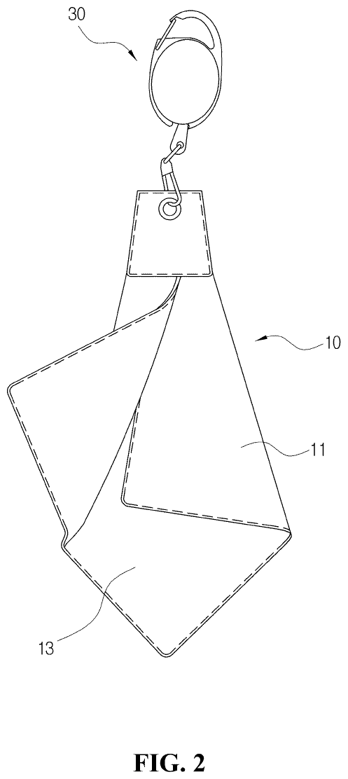

In the present invention, as the magnet member 200 may be provided in the golf article cleaner 100, as illustrated in FIG. 4, the golf article cleaner 100 may be opened in a wider state than the open state of the cleaner illustrated in (b) of FIG. 1 according to the related art. That is, as illustrated in FIG. 3, the magnet member 200 is provided on an upper portion of the golf article cleaner 100 to be spaced a certain distance from a side surface 112, for example, at approximately two-thirds of the upper portion. Thus, as illustrated in FIG. 4, a portion of the upper portion of the inner surface portion 120 may be maintained open beyond an edge portion of the side surface 112. Thus, as illustrated in FIG. 4, in an open state of the golf article cleaner 100 according to the present invention, an open area P may be wider than the cleaner illustrated in FIG. 1 according to the related art, and thus golf articles having various sizes can be easily cleaned.

The above-described certain distance is not limited to a specific value and may be provided from a central portion of the upper portion of the golf article cleaner 100 toward the side surface 112 so that the state of FIG. 3 may be maintained due to an attractive force of the magnet member 200, and the embedded position of the magnet member 200 may be changed according to the size of the golf article cleaner 100, the size of the magnet, and the intensity of a magnetic force.

As illustrated in FIGS. 4 and 5, the outer surface portion 110 has a structure in which the outer surface portion 110 is sewn around the inner surface portion 120 by a finishing member 111, but the present invention is not limited thereto, and edge portions of the outer surface portion 110 and the inner surface portion 120 may be provided to be integrally formed with each other by sewing. Further, the outer surface portion 110 is made of a waterproof material or a waterproof-treated material. That is, for example, the interior or exterior of the outer surface portion 110 may be made of a waterproof-treated material or a material having a waterproof function, such as artificial leather. Thus, even when the inner surface portion 120 is wet due to moisture or the like in a process of cleaning the golf article or is contaminated with foreign substances attached thereto after the golf article is cleaned, as illustrated in FIG. 3, the inner surface portion 120 is maintained in a stacked state, the outer surface portion 110 may be maintained in a dry state, and thus clothing of the user is not contaminated.

As illustrated in FIG. 5, the inner surface portion 120 includes a first inner surface portion 123 and a second inner surface portion 124 continuing from the first inner surface portion 123, which are divided in a stacked state, and an upper portion of the first inner surface portion 123 and an upper portion of the second inner surface portion 124 may be separately deployed to expand the cleaning area. That is, as illustrated in FIG. 5, the first inner surface portion 123 and the second inner surface portion 124 are portions divided for convenience of description in a structure in which a first cleaning member 121 and a second cleaning member 122 are serially and integrally woven in a longitudinal direction.

Each of the first inner surface portion 123 and the second inner surface portion 124 may be provided with the first cleaning member 121 and the second cleaning member 122 provided in succession with the first cleaning member 121, and the first cleaning member 121 and the second cleaning member 122 may have different structures.

Further, the first cleaning member 121 and the second cleaning member 122 may be provided to be symmetric to each other in a front-rear direction and a vertical direction. In FIG. 5, the first cleaning member 121 and the second cleaning member 122 provided on the inner surface portion 120 may have a continuous wave-shaped structure in the longitudinal direction, but the present invention is not limited thereto, and a continuous wave-shaped structure in a width direction of the inner surface portion 120 may be applied.

Further, FIGS. 4 and 5 illustrate a structure in which the first cleaning member 121 and the second cleaning member 122 are serially formed in a trapezoidal shape, but the present invention is not limited thereto, and the first cleaning member 121 and the second cleaning member 122 may be provided in a triangular shape, a quadrangular shape, or a circular shape.

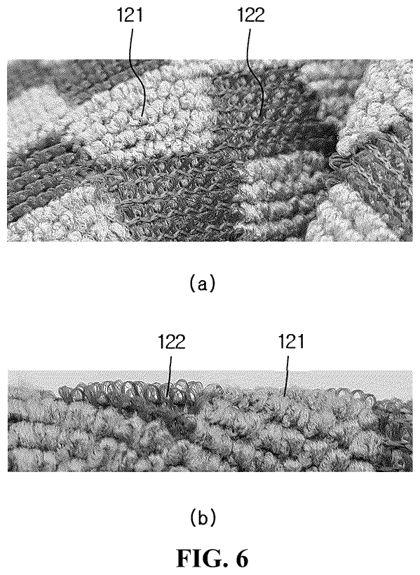

As illustrated in FIG. 6, the first cleaning member 121 may be made of a terry fabric to clean foreign substances attached to a surface of the golf article, and the second cleaning member 122 may be made of a loop-shaped weave to clean foreign substances attached to the surface and grooves of the golf article. FIG. 6 is an enlarged picture of the washing member illustrated in FIG. 5, wherein (a) of FIG. 6 is an enlarged picture of the first cleaning member 121 and the second cleaning member 122, and (b) of FIG. 6 is a picture illustrating a shape of the second cleaning member 122.

As illustrated in (a) and (b) of FIG. 6, the first cleaning member 121 may be formed of, for example, a terry cloth made of microfibers, to be suitable for cleaning foreign substances attached to the surface of the golf article, and accordingly, may be provided to easily absorb moisture.

As illustrated in (b) of FIG. 6, the second cleaning member 122 is made of the loop-shaped weave and is suitable for removing foreign substances attached to the grooves of the golf article, for example, dimple portions of the golf ball or a groove of the golf club head or foreign substances, such as mud or grass, attached to the surface of the golf article and not easily separated therefrom. For example, a loop-shaped weave made of untwisted yarn, a loop-shaped weave made of false-twisted yarn such as hard nylon yarn or Kevlar, or the like may be applied as the above-described loop-shaped weave.

Further, since the first cleaning member 121 and the second cleaning member 122 are made of the same fabric to be woven at once, manufacturing costs can be decreased, and cleaning efficiency can be improved. Further, the first cleaning member 121 and the second cleaning member 122 may be manufactured to include silver fibers and charcoal fibers that have antibacterial properties and deodorizing properties against contaminants or may be manufactured to contain fragrance ingredients.

As illustrated in FIG. 5, the magnet member 200 may include a first magnet member 210 provided at an upper portion of the first inner surface portion 123 and a second magnet member 220 provided at an upper portion of the second inner surface portion 124, and as illustrated in FIG. 3, the first inner surface portion 123 and the second inner surface portion 124 may be maintained in a stacked state due to an attractive force between the first magnet member 210 and the second magnet member 220. The first magnet member 210 and the second magnet member 220 may be arranged to be spaced a certain distance from the side surface 112 of the outer surface portion 110.

Further, when the first magnet member 210 and the second magnet member 220 are separated, that is, when an upper portion of the first inner surface portion 123 and an upper portion of the second inner surface portion 124 are separated and deployed, as illustrated in FIG. 5, the cleaning area may expand, and thus both the first inner surface portion 123 and the second inner surface portion 124 may be used for cleaning the golf article.

Meanwhile, as illustrated in FIG. 3, an eyelet 20 passing through the outer surface portion 110, the first inner surface portion 123, and the second inner surface portion 124 may be provided at a stacked portion of the upper portion of the first inner surface portion 123 and the upper portion of the second inner surface portion 124, a connection ring 31 may be coupled to the eyelet 20, and a reel wire 30 may be connected to the connection ring 31. Thus, when the first inner surface portion 123 and the second inner surface portion 124 are deployed, as illustrated in FIG. 5, an upper portion in which the first inner surface portion 123 and the second inner surface portion 124 are in contact with each other is not deployed by the eyelet 20.

A wire having a length of 60 cm to 100 cm may be wound around the reel wire 30, an automatic winding function after the wire is withdrawn may be provided, and an O-type or D-type karabiner ring or a clamp-shaped clip may be provided for wearing on the user's golf bag or belt.

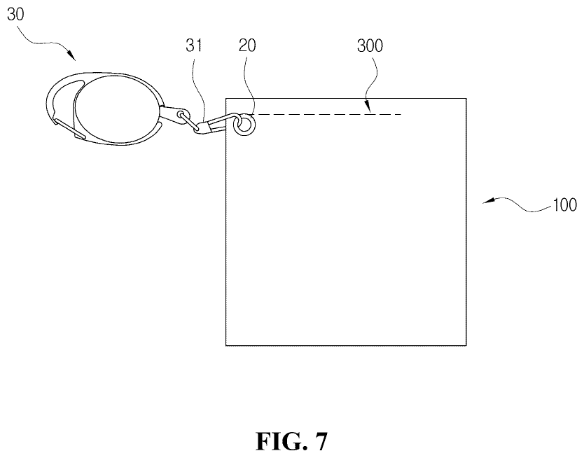

In the description of the first embodiment, the golf article cleaner 100, which uses the magnet member 200 to expand the cleaning area and may be maintained in a roughly quadrangular folded state, has been described. However, as illustrated in FIG. 7, an open state as illustrated in FIG. 4 may be provided by sewing 300 to a position of the magnet member 200 illustrated in FIG. 3. FIG. 7 is a view illustrating a modified example of the golf article cleaner according to the first embodiment of the present invention. Thus, even in the modified example of the golf article cleaner according to the first embodiment of the present invention, the golf article cleaner may be provided with an open area P that is wider than the cleaner in an open state according to the related art illustrated in (b) of FIG. 1.

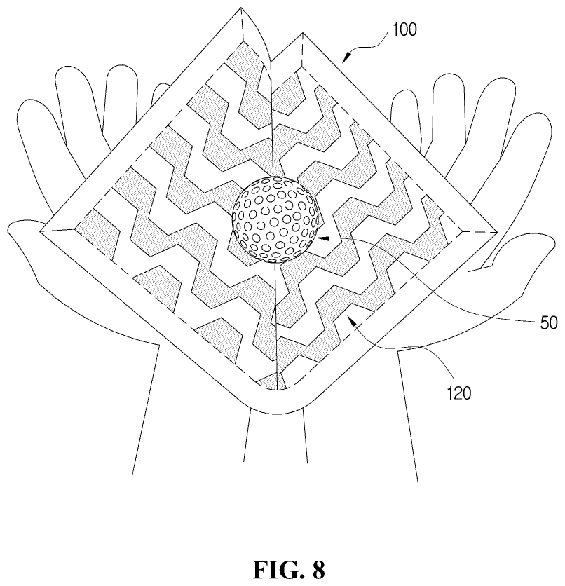

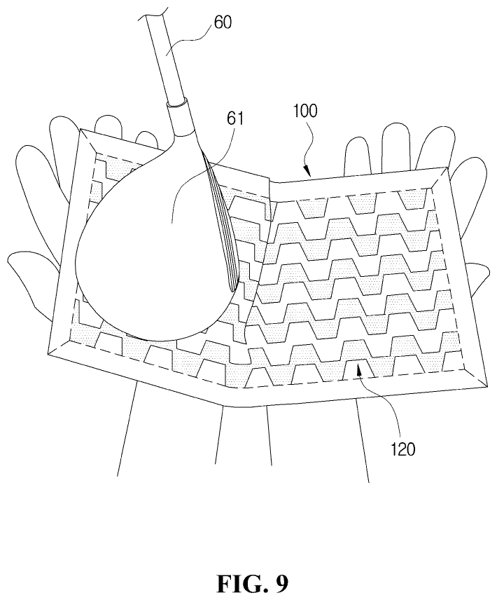

Next, an example of a usage state of the golf article cleaner 100 according to the first embodiment and the modification of the present invention will be described with reference to FIGS. 8 and 9.

FIG. 8 is a view for describing a state of cleaning a golf ball using the golf article cleaner according to the first embodiment and the modified example of the present invention, and FIG. 9 is a view for describing a state of a golf club head being cleaned using the golf article cleaner according to the first embodiment of the present invention.

When the golf ball 50 is cleaned using the golf article cleaner 100 according to the first embodiment or the modified example of the present invention, as illustrated in FIG. 8, the cleaning may be performed using both hands, and thus the cleaning may be performed conveniently and precisely as compared to a technology according to the related art. Further, since the first cleaning member 121 and the second cleaning member 122 are provided on the inner surface portion 120 that cleans the golf ball 50, the dimple portions may be cleanly cleaned as well as the surface of the golf ball 50.

Further, as illustrated in FIG. 5, to expand the cleaning area, the first inner surface portion 123 and the second inner surface portion 124 of the inner surface portion 120 are separated and deployed by separating the magnet member 200. Thus, as illustrated in FIG. 9, a relatively large club head 61 of a driver 60 may also be easily cleaned using the user's both hands, and grooves may be cleanly cleaned as well as a surface of the club head 61 by the first cleaning member 121 and the second cleaning member 122. Further, even when the inner surface portion 120 is wet with water or has contaminants attached thereto in the process of cleaning the golf article, the waterproof-treated outer surface portion 110 may be maintained in a dry state, the inner surface portion 120 may be maintained in a stacked state, and thus the clothing of the user is not contaminated.

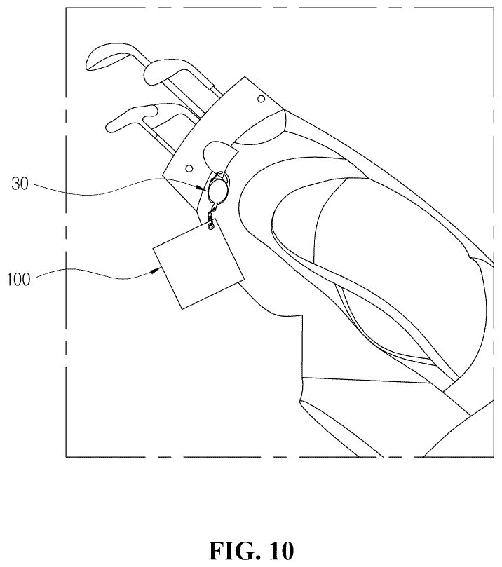

Meanwhile, as illustrated in FIGS. 10 to 12, the golf article cleaner 100 according to the first embodiment of the present invention may be used while attached to the clothing, the golf bag, or the like of the user.

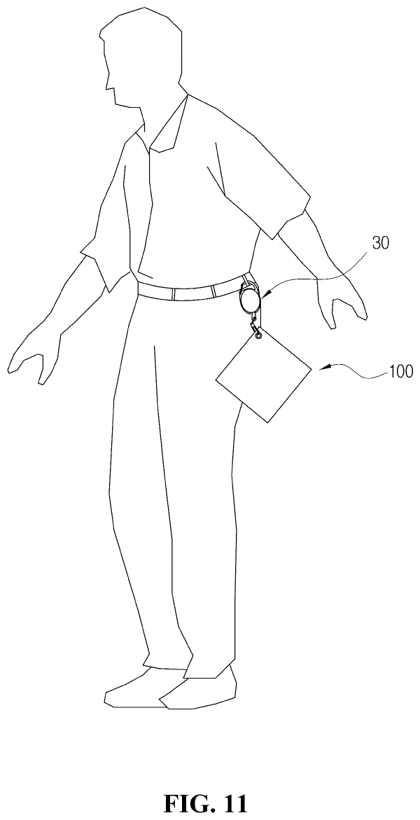

FIGS. 10 to 12 are views for describing a mounting state of the golf article cleaner according to the present invention, FIG. 10 illustrates an example in which the golf article cleaner 100 is mounted on the golf bag by the karabiner ring provided in the reel wire 30, and FIG. 11 illustrates an example in which the golf article cleaner 100 is mounted on a belt loop of pants that is the clothing of the user.

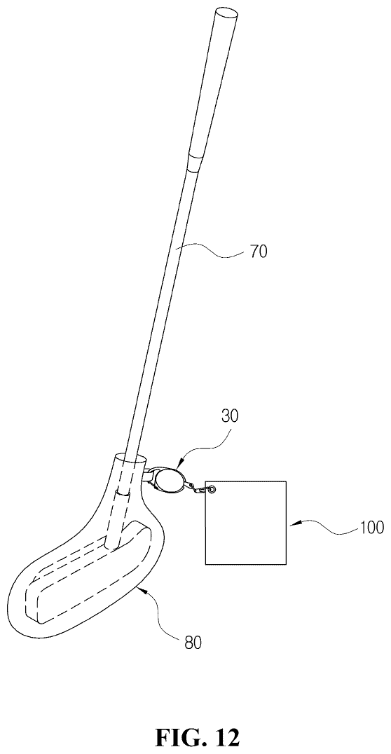

Further, as illustrated in FIG. 12, the golf article cleaner 100 according to the present invention may be used while connected to a putter cover 80 for a putter 70. Thus, when the putter 70 is used, when the putter cover 80 is separated and left around the golf course, loss of the putter cover 80 can be prevented.

### SECOND EMBODIMENT

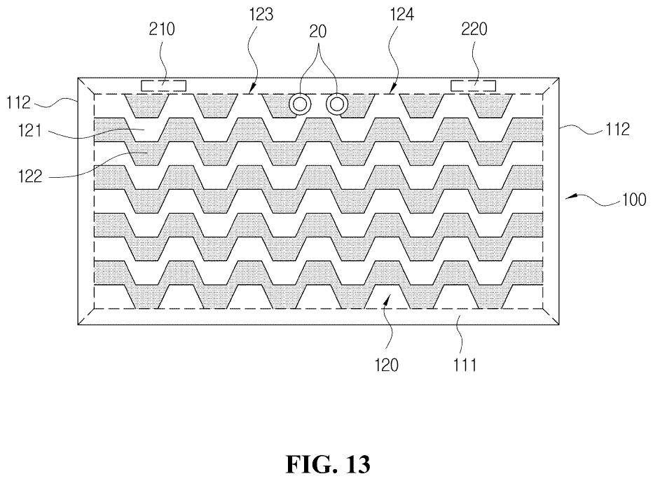

Next, a second embodiment according to the present invention will be described with reference to FIG. 13.

Further, in the second embodiment, the same components as those in the first embodiment are designated by the same reference numerals, and repeated descriptions thereof will be omitted.

FIG. 13 is a view illustrating a golf article cleaner according to the second embodiment of the present invention.

In the first embodiment, a structure in which one eyelet 20 is provided to pass through the outer surface portion 110, the first inner surface portion 123, and the second inner surface portion 124 is provided. However, in the second embodiment, as illustrated in FIG. 13, the eyelet 20 may be provided at an upper portion of the first inner surface portion 123 and an upper portion of the second inner surface portion 124.

Thus, when the first magnet member 210 and the second inner surface portion 124 are deployed, as illustrated in FIG. 13, the entireties of the first inner surface portion 123 and the second inner surface portion 124 may be maintained in an open state, and thus the cleaning area can further expand as compared to the deployed state illustrated in FIG. 5.

### THIRD EMBODIMENT

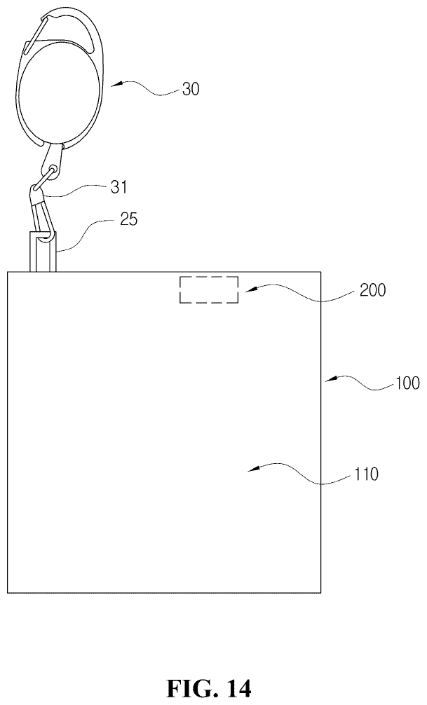

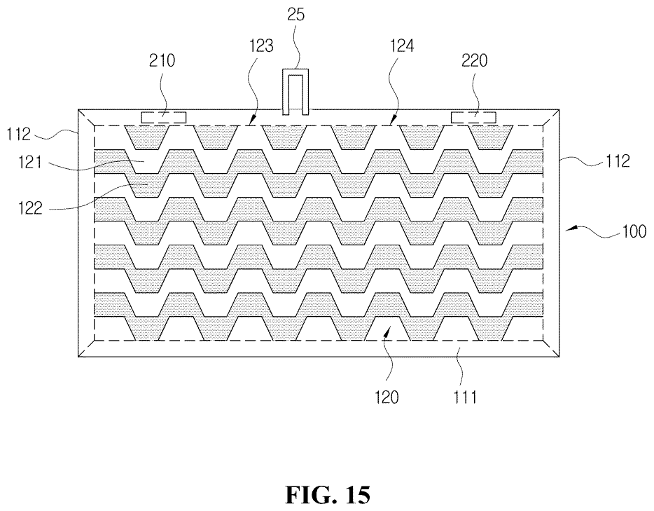

Next, a third embodiment according to the present invention will be described with reference to FIGS. 14 and 15.

Further, even in the third embodiment, the same components as those in the first embodiment are designated by the same reference numerals, and repeated descriptions thereof will be omitted.

FIG. 14 is a view illustrating a golf article cleaner according to a third embodiment of the present invention, and FIG. 15 is a view illustrating a deployed state of the golf article cleaner illustrated in FIG. 14.

In the first embodiment and the second embodiment described above, a structure in which the eyelet 20 is applied has been described. However, in the third embodiment, a ring member 25 is provided on one upper side of the outer surface portion 110. That is, as illustrated in FIG. 14, a ring shape may be provided using sewing, and for example, the ring member 25 made of the same material as the outer surface portion 110 may be applied.

As illustrated in FIG. 15, for example, the ring member 25 may be provided by sewing at a portion of the finishing member 111 on the first inner surface portion 123. Thus, when the first magnet member 210 and the second inner surface portion 124 are deployed, as in the second embodiment, the entireties of the first inner surface portion 123 and the second inner surface portion 124 may be maintained in an open state.

### FOURTH EMBODIMENT

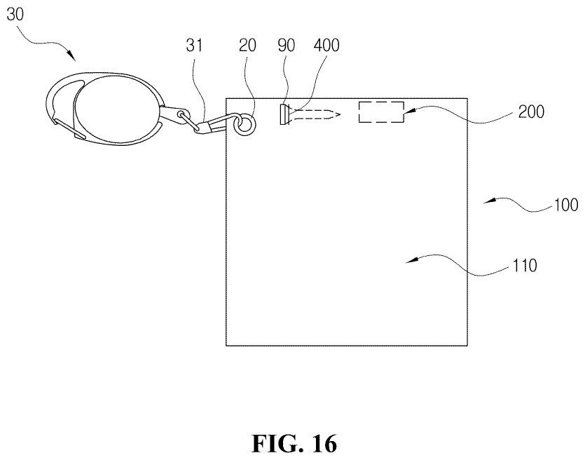

Next, a structure for easily accommodating the golf article in the golf article cleaner in a fourth embodiment of the present invention will be described with reference to FIGS. 16 to 19.

FIGS. 16 to 19 are views of a fourth embodiment to which the golf article cleaner illustrated in FIG. 3 is applied.

As illustrated in FIG. 16, the golf article cleaner 100 according to the present invention is provided with an insertion portion 400 to accommodate a golf tee 90 in the cleaner. The insertion portion 400 may be provided to be cut by a certain length so that a head portion of the golf tee 90 may be exposed to a peripheral portion of the outer surface portion 110. FIG. 16 illustrates a structure in which the insertion portion 400 is provided on an upper side of the outer surface portion 110, but the present invention is not limited thereto, and the insertion portion 400 may be provided on a side surface or a lower portion of the outer surface portion 110.

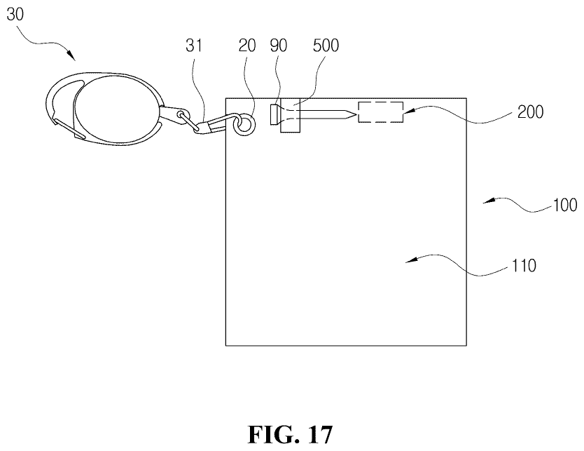

Further, FIG. 16 illustrates a structure in which the golf tee 90 is provided by cutting the peripheral portion of the outer surface portion 110, but as illustrated in FIG. 17, a structure in which a ring-shaped advertisement display member 500 is provided on the outer surface portion 110 of the golf article cleaner 100 and the golf tee 90 is inserted into the advertisement display member 500 may be applied. That is, the relatively short golf tee 90 may be applied to a structure inserted into the outer surface portion 110 through the insertion portion 400 as illustrated in FIG. 16, and the relatively long golf tee 90 may be provided in a structure inserted into the ring-shaped advertisement display member 500 as illustrated in FIG. 17. Further, FIG. 17 illustrates a structure in which the advertisement display member 500 is provided on the upper side of the outer surface portion 110, but the present invention is not limited thereto, and the advertisement display member 500 may be provided on the side surface or the lower portion of the outer surface portion 110.

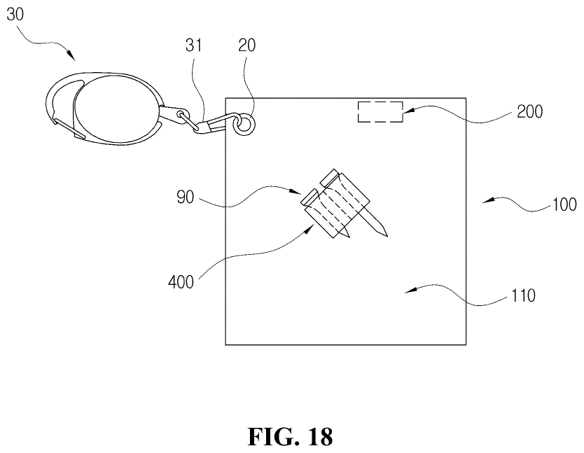

Meanwhile, FIG. 16 illustrates a structure in which the insertion portion 400 is provided by cutting the peripheral portion of the outer surface portion 110, but to accommodate a pair of golf tees having different lengths, as illustrated in FIG. 18, the insertion portion 400 may be provided on a surface of the outer surface portion 110 by sewing.

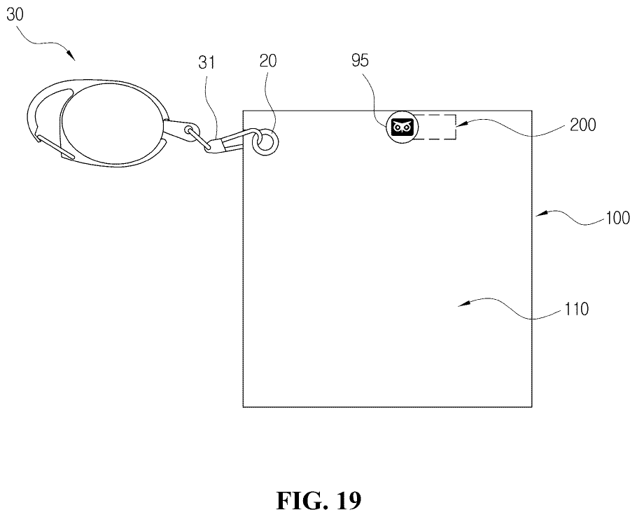

Further, as illustrated in FIG. 19, the magnet member 200 provided in the golf article cleaner 100 according to the present invention may be provided in a structure in which a ball marker 95 made of a metal material is attached by a magnetic force.

As described above, since the golf article cleaner 100 according to the fourth embodiment of the present invention is provided, the golf article such as the golf tee and the ball marker can be easily accommodated in the cleaner, and thus convenience of use can be achieved.

Further, in a golf game, when the golf tee is used or the ball marker is used, the cleaning of the golf article can be accurately applied using the cleaner.

Hereinabove, the invention made by the present inventor has been described in detail according to embodiments. However, the present invention is not limited to the embodiments, and it is obvious that the present invention may be changed in various manners without departing from the subject matter thereof.

### INDUSTRIAL APPLICABILITY

By using the golf article cleaner according to the present invention, foreign substances attached to the surface and grooves of the golf article can be easily cleaned.

1. A golf article cleaner for cleaning various golf articles, the golf article cleaner comprising:
an inner surface portion functioning as an inner skin and configured to clean the golf article; and
an outer surface portion functioning as an outer skin and sewn around the inner surface portion,
wherein the inner surface portion includes a first inner surface portion and a second inner surface portion continuing from the first inner surface portion, which are divided in a stacked state, and
an upper portion of the first inner surface portion and an upper portion of the second inner surface portion are detachably deployed to expand a cleaning area.

2. The golf article cleaner of claim 1, wherein the first inner surface portion and the second inner surface portion are provided with a first cleaning member and a second cleaning member provided with the first cleaning member in series, respectively, and
the first cleaning member and the second cleaning member have different structures.

3. The golf article cleaner of claim 2, wherein the first cleaning member is made of a terry fabric to clean foreign substances attached to a surface of the golf article, and
the second cleaning member is made of a loop-shaped weave to clean foreign substances attached to the surface and grooves of the golf article.

4. The golf article cleaner of claim 2, further comprising a magnet member provided to expand the cleaning area,
wherein the magnet member includes a first magnet member provided at the upper portion of the first inner surface portion and a second magnet member provided at the upper portion of the second inner surface portion, and
the first inner surface portion and the second inner surface portion are maintained in a stacked state due to an attractive force between the first magnet member and the second magnet member.

5. The golf article cleaner of claim 4, wherein each of the first magnet member and the second magnet member is arranged to be spaced a certain distance from a side surface of the outer surface portion.

6. The golf article cleaner of claim 2, wherein the upper portion of the first inner surface portion and the upper portion of the second inner surface portion part are sewn to be spaced a certain distance from a side surface of the outer surface portion.

7. The golf article cleaner of claim 2, wherein the first cleaning member and the second cleaning member are provided symmetrically to each other in a front-rear direction and a vertical direction.

8. The golf article cleaner of claim 2, wherein the outer surface portion is made of a waterproof material or a waterproof-treated material.

9. The golf article cleaner of claim 2, wherein an eyelet passing through the outer surface portion, the first inner surface portion, and the second inner surface portion is provided at a stacked portion of the upper portion of the first inner surface portion and the upper portion of the second inner surface portion, and
a connection ring is coupled to the eyelet, and a reel wire is connected to the connection ring.

10. The golf article cleaner of claim 2, wherein an eyelet is provided at each of the upper portion of the first inner surface portion and the upper portion of the second inner surface portion, and
a connection ring is coupled to the eyelet, and a reel wire is connected to the connection ring.

11. The golf article cleaner of claim 2, wherein a ring member is provided at an upper portion of the outer surface portion, and
a connection ring is coupled to the ring member, and a reel wire is connected to the connection ring.

12. The golf article cleaner of claim 2, wherein an insertion portion into which the golf article is inserted is provided on the outer surface portion.

13. The golf article cleaner of claim 2, wherein a ring-shaped advertisement display member is provided on the outer surface portion, and the golf article is inserted into the advertisement display member.

14. The golf article cleaner of claim 4, wherein the golf article made of a metal material is attached to the magnet member.
